(19) United States
(12) Patent Application Publication
(10) Pub. No.: US 2008/0047401 A1
(43) Pub. Date: Feb. 28, 2008

(54) TORQUE CONNECTING MECHANISM

(76) Inventor: Sui-Lan Lu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/509,787

(22) Filed: Aug. 25, 2006

(51) Int. Cl. B25B 23/16; B25G 1/04

(52) U.S. Cl. 81/177.2; 81/478; 81/471

(57) ABSTRACT

The present invention relates to a torque connecting mechanism, which comprises a connecting rod with a continuous indicating part and a strength control part, the indicating part and strength control part are implemented at a location where torque strength or other stress is easy to be concentrated. The indicating part extends along the axis of the connecting rod. A stop part is implemented on the connecting rod, and strength indicating mechanisms are provided on both sides of the stop part, a lock ring is utilized to make a rotation handle stay securely around the connecting rod. The rotation handle has a base line for coinciding with a base point on the driving end of the connecting rod, which makes the base line of the rotation handle become another strength indicating mechanism of the stop part of the connecting rod. So it is easy to notice the condition of the deformation on the connecting rod whether the rotation handle is mounted on or detached from the connecting rod. When the connecting rod breaks, it will be only on the strength control part, and the connecting rod still stays securely within the rotation handle. Then the objective of safety in use and integrated optimal practicality is attained.

### FIELD OF THE INVENTION

The present invention relates to a torque connecting mechanism, and more particularly to a connecting mechanism for connecting with pneumatic or power driving tools, with implementation of a rotation handle stop mechanism and a strength control indicating mechanism in the grooved connecting rod, the objective of integrated optimal practicality would be attained.

### BACKGROUND OF THE INVENTION

Conventional connecting mechanisms are generally a kind of a cylindrical rod that has one bigger driving end with a square concavity and one smaller square driven end, when such a mechanism is used on pneumatic or power driving tools, the speed of rotation is so fast that sometimes a user has to hold on the connecting mechanism to prevent it from slanting. Normally in usual operation, all works have to be ceased until a user to hold the connecting mechanism right, then the operation can proceed, which is extremely inconvenient in use and operation, causing an unconquerable problem for the conventional connecting mechanism to work with pneumatic or power driving tools.

### SUMMARY OF THE INVENTION

### <Technical Problems to be Resolved>

Being aware of the shortcomings mentioned above, to have the connecting mechanism able to work with the connecting rods of the pneumatic or power driving tools in high speed, and equipped with strength control and indicating mechanism, the inventors develop a torque connecting mechanism of the present invention that can resolve the technical problems of the shortcomings.

### <Technical Measures and Efficacies>

The main purpose of the present invention is to provide a torque connecting mechanism, onto which a grooved stop part is implemented and strength indicating mechanism is provided on both sides of the stop part, a lock ring is utilized to make a rotation handle stay on the connecting rod forming a structure of rotational grip, then the need for a user to hold on the connecting mechanism in operation of pneumatic or power tools is satisfied and the objective of optimal practicality would be attained.

The other purpose of the present invention is to provide a torque connecting mechanism with continuous torque indicating part, with which a torque bearing status can be realized for a user to understand the structural status of the tool, and then the objective of controlling to optimal safety would be attained.

Another purpose of the present invention is to provide a torque connecting mechanism with strength control part which is implemented at a location where torque strength or other stress is easy to be concentrated and hidden in the rotating handle, when the torque strength or other stress is too big for the connecting rod to bear and breaks, the breaking location is confined within the strength control part, the connecting rod keeps connected with the rotation handle, and then the objective of optimal safety would be attained.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the present invention;

FIG. 2 is an exploded view of the present invention;

FIG. 3 is a sectional view shows the safety in use of the connecting mechanism of the present invention;

FIG. 4 is a partial plan view of the connecting rod of the present invention;

FIG. 5 is a partial plan view of the connecting rod being deformed of the present invention;

FIG. 6 is a partial plan view of the mark units and the indicating part of the present invention; and

FIG. 7 is a partial plan view of another embodiment of the connecting rod of the present invention.

### DETAILED DESCRIPTION OF THE PREFERRED EMBODIMENT

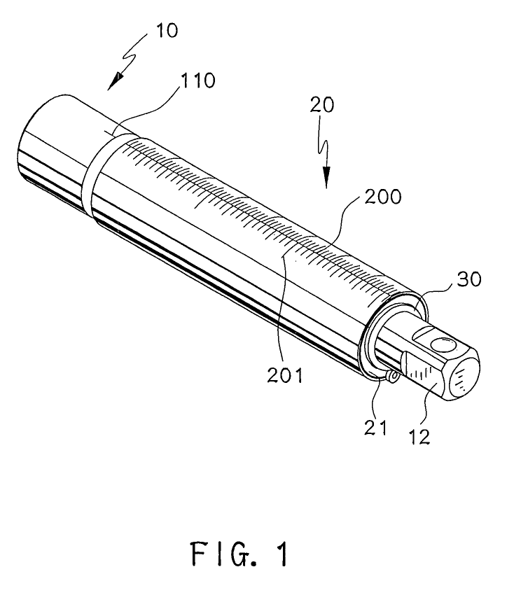

Referring to FIG. 1 of the drawings, a connecting rod 10, the same as the traditional connecting rod in structure, is a cylindrical rod that has one end formed a bigger diameter driving end 11 with a square concavity and the other formed a smaller diameter square driven end 12. The features of the present invention are:

The connecting rod 10 has a grooved stop part 13 on proper location for implementing indicating mechanisms and a rotation handle 20.

Wherein the rotation handle 20 is mounted around the connecting rod 10, with cooperation of a lock ring 30 engaged on the stop part 13 of the connecting rod 10, the rotation handle 20 stays securely around the connecting rod 10 and is able to rotate thereon, which is convenient for the user to hold on directly while the connecting rod 10 is driven by pneumatic or power driving tools.

The rotation handle 20 is equipped with two bearings 21 on both ends. The outer peripheries of the bearings 21 are in tight fit with the inside of the rotation handle 20, the inner peripheries of the bearings 21 are in loose fit with the connecting rod 10, therefore the rotation handle 20 can be detached or mounted on the connecting rod 10 anytime.

The both sides of the stop part 13 of the connecting rod 10 of the present invention and the surface of the rotation handle 20 can all implement strength indicating mechanisms, wherein the both sides of the stop part 13 of the connecting rod 10 respectively have a continuous indicating part 14, a positioning reference point 15 and warning parts 16 on both sides of the positioning reference point 15. A concave strength control part 17 is implemented on the middle portion between the driving end 11 and the driven end 12. In addition, a base point 110 is implemented at the location where the connecting rod 10 is not covered by the rotation handle 20. A base line 200 in form of straight line is implemented on the surface of the rotation handle 20, and both sides of the base line 200 have S.I. or Imperial. Standard scales 201 respectively.

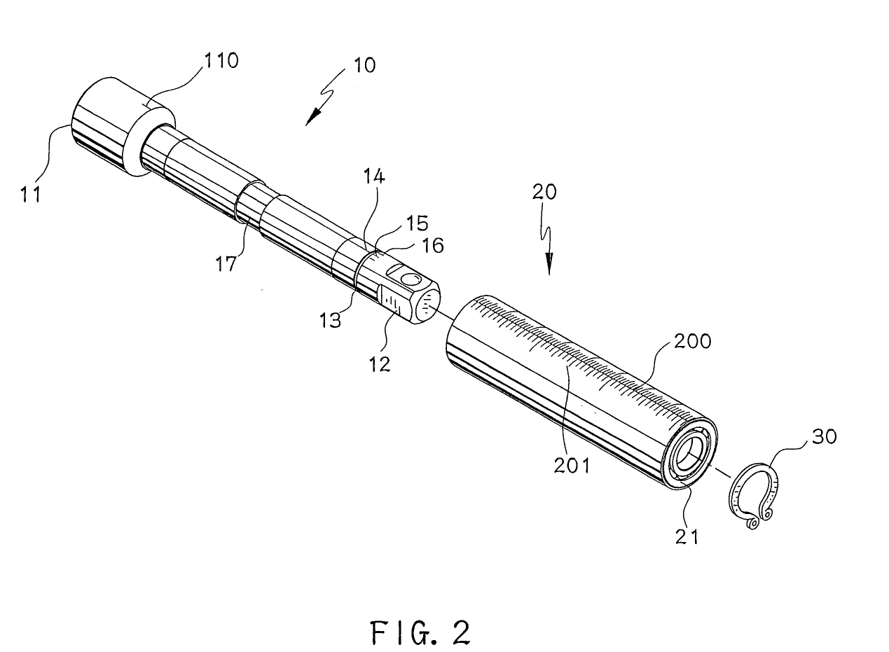

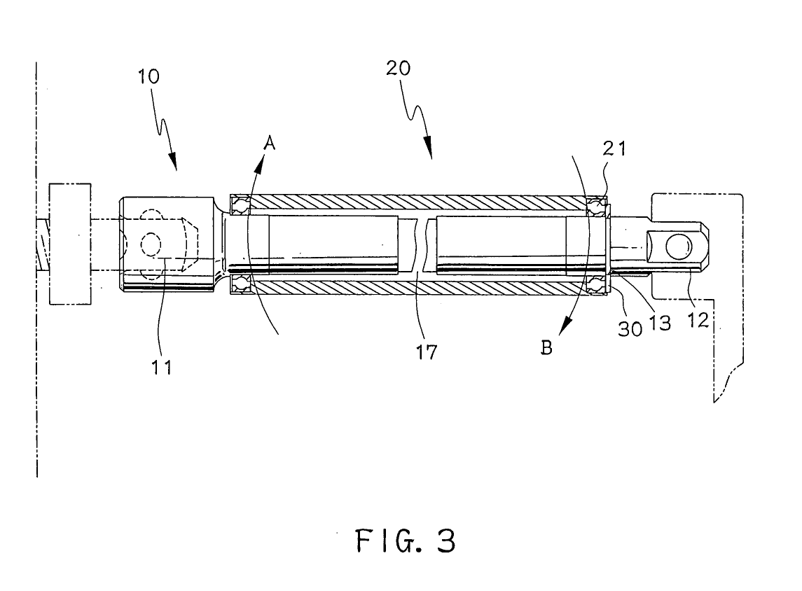

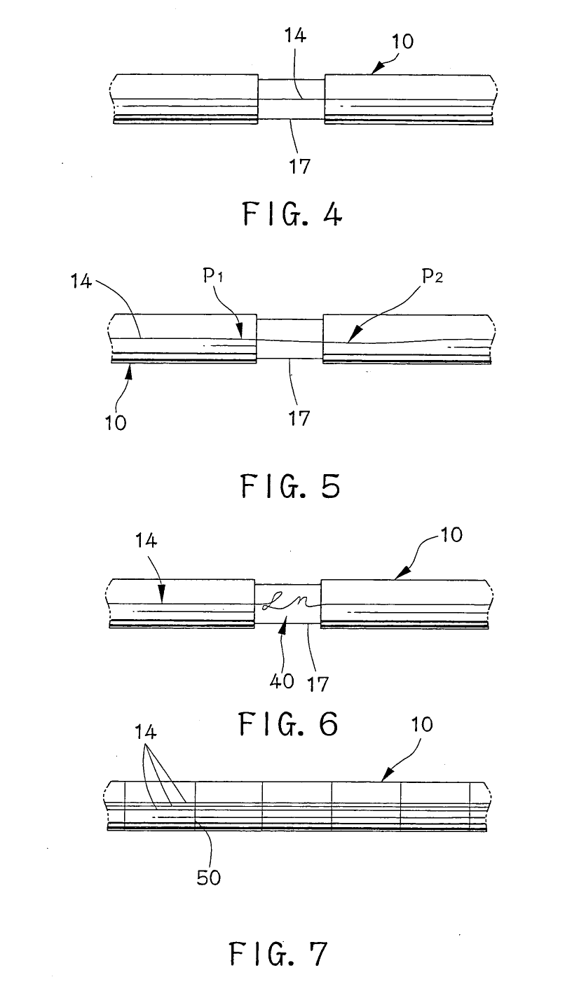

In such structure when the connecting rod 10 is used without the rotation handle 20, it can be used generally as a connecting rod 10 with strength control and indicating mechanism. Referring to FIG. 2, the rotation handle 20 is mounted around the connecting rod 10, with cooperation of the lock ring 30 engaged on the stop part 13 of the connecting rod 10, the rotation handle 20 stays securely around the connecting rod 10 and is able to rotate thereon. Therefore, while the connecting rod 10 is driven by pneumatic or power driving tools, the user can still hold on the outside of the rotation handle 20. After a period of time of using, the structure of the connecting rod 10 maybe in status of inner stress destruction, that is, the portions of both sides of the stop part 13 will be shifted, which means that the indicating part 14 can not be in line with the positioning reference point 15. Meanwhile, the indicating part 14 is covered by the rotation handle 20, the user is unable to notice that, therefore, the user can rotate the rotation handle 20 to have one end of the base line 200 coincide with the base point 100 on the connecting rod 10, with reference of the relativity between the other end of the base line 200, the positioning reference point 15 and the warning parts 16 on both sides. The condition of whether the connecting rod 10 being excessively deformed is realized for replacement, therefore the objectives of safety in use, as well as convenience in use will be attained.

Wherein the connecting rod 10 is mounted inside the rotation handle 20, the connecting rod 10 implements the strength control part 17 on the middle portion, as shown in FIG. 3. The user mounts the driving end 11 on a workpiece as a force reaction end (A), and the driven end 12 on a sleeve with handle as a force applying end (B). If the user is over applying force leading the strength control part 17 unbearable, the connecting rod 10 will break only within the rotation handle 20, causing the rotation being void to prevent the user from injury, then the objective of safety in use will be attained.

Wherein the indicating part 14 may be in structure of a simple straight line as shown in FIG. 4, the indicating part 14 is a continuous solid line. The first embodiment is that the indicating part 14 is in straight status and extends along the axis of the connecting rod 10. When the connecting rod 10 is forced by improper torque strength or the life time is due, the inner structure of the connecting rod 10 is changed, at this time the connecting rod 10 might cause unnecessary deformation as shown in FIG. 5. The place of stress concentration creates unnecessary twist, which causes changes in the indicating part 14 as shown in figure, the indicating part 14 is formed a continuous first turning point P1 and second turning point P2 thereon. When the turning points are formed, it is easy to be noticed by the user. In this condition, the user can decide whether the connecting rod 10 needs to be replaced or not, to meet the safety requirement.

Another embodiment is that the indicating part 14 includes mark units 40 designed as continuous shapes in schemes or alphabets as shown in FIG. 6. Wherein the mark units 40 may be ordinary marking of trademarks, scales, notes of S.I. or Imperial standard, or else.

The overall design can be as shown in FIG. 7, the indicating part 14 can be designed as multiple parallel straight lines, some baselines 50 can be provided in equal distance on the indicating part 14 for indication of standard observation sections, therefore the objectives of easy observation and optimal safety will be attained.

With implementation of the structure described above, the functions as follows would be derived:

1. Varieties of usages: with the implementation of the stop part 13 of the connecting rod 10 and the cooperation of the rotation handle 20, the rotation handle 20 can be mounted on or detached from at anytime to meet different requirements and the function of varieties of usages will be attained.

2. Remain the function of the strength control and indication: no matter the rotation handle 20 is mounted on or detached from the connecting rod 10, the function of strength indication can be efficiently remained, function of strength control and indication is extremely improved.

3. The scale 201 on the rotation handle 20 can be used as a rough reference in measurement, it can be used as a scale in hands when a measurement is needed temporarily, and the objective of quick in use will be attained.

While we have shown and described the embodiment in accordance with the present invention, it should be clear to those skilled in the art that further embodiments may be made without departing from the scope of the present invention.

1. A torque connecting mechanism comprising:
a connecting rod with a driving end and a driven end; and
a recessed groove formed on said connecting rod for implementing indicating mechanisms;
a rotatable handle disposed about said connecting rod;
strength indicating mechanisms positioned on opposing sides of said recessed groove and a surface of said rotatable handle, said opposing sides of said recessed groove respectively haying an indicating part, a positioning reference point and warning points on both sides of said positioning reference point;
a base point positioned at said driven end of said connecting rod where said connecting rod is uncovered by said rotatable handle; and
a base line disposed on said surface of said rotatable handle.

2. A torque connecting mechanism comprising:
a connecting rod with a driving end and a driven end;
a recessed groove formed on said connecting rod; and
a rotatable handle mounted around said connecting rod with cooperation of a lock ring engaged on said recessed groove of said connecting rod;
strength indicating mechanisms positioned on opposing sides of said recessed groove and a surface of said rotatable handle, said opposing sides of said recessed groove respectively having an indicating part, a positioning reference point and warning points on both sides of said positioning reference point;
a base point positioned at said driven end of said connecting rod where said connecting rod is uncovered by said rotatable handle; and
a base line disposed on said surface of said rotatable handle.

3. The torque connecting mechanism as claimed in claim 1 or 2, wherein both ends of said rotatable handle include bearings.

4. The torque connecting mechanism as claimed in claim 1, wherein both sides of said base line of said rotatable handle have S.I. or Imperial Standard scales respectively.

5. The torque connecting mechanism as claimed in claim 2, wherein both sides of said base line of said rotatable handle have S.I. or Imperial Standard scales respectively.

6. (canceled)

7. The torque connecting mechanism as claimed in claim 2, wherein said indicating part is in structure of a continuous line.

8. The torque connecting mechanism as claimed in claim 2, wherein said indicating part is in structure of several continuous lines in parallel.

9. The torque connecting mechanism as claimed in claim 2, wherein said indicating part is in structure of several continuous straight lines in parallel.

10. The torque connecting mechanism as claimed in claim 2, wherein said indicating part includes continuous mark units.

11. The torque connecting mechanism as claimed in claim 2, wherein said indicating part includes continuous mark units, said mark units are trademarks, schemes or alphabets.

12. The torque connecting mechanism as claimed in claim 2, wherein said indicating part has some baselines implemented in equal distance.

13. A torque connecting mechanism comprising:
a connecting rod with a driving end and a driven end;
a first recessed groove formed on said connecting rod; and
a rotatable handle mounted around said connecting rod with cooperation of a lock ring engaged on a second recessed groove of said connecting rod.

14. (canceled)

15. The torque connecting mechanism as claimed in claim 13, wherein said first recessed groove is designed as art figures of circumferential teeth or oval shape.

16. The torque connecting mechanism as claimed in claim 13, wherein said first recessed groove is hidden inside said rotatable handle.

17. The torque connecting mechanism as claimed in claim 13, wherein said first recessed groove is implemented at a location where torque strength or other stress is easy to be concentrated.
